(19) United States
(12) Patent Application Publication
(10) Pub. No.: US 2020/0242345 A1
(43) Pub. Date: Jul. 30, 2020

(54) DETECTION APPARATUS AND METHOD, AND IMAGE PROCESSING APPARATUS AND SYSTEM

(71) Applicant: CANON KABUSHIKI KAISHA, Tokyo (JP)

(72) Inventors: Yaohai Huang, Beijing (CN); Xin Ji, Beijing (CN)

(21) Appl. No.: 16/773,755

(22) Filed: Jan. 27, 2020

(30) Foreign Application Priority Data
Jan. 30, 2019 (CN) 201910089715.1

(51) Int. Cl. G06K 9/00; G06K 9/46; G06T 7/73

(52) U.S. Cl. CPC G06K 9/00362; G06K 9/46; G06T 7/73; G06T 2207/20081; G06T 2207/20084; G06T 2207/10016; G06T 2207/30196

(57) ABSTRACT

A detection method including extracting features from an image, detecting a human in the image based on the extracted features, detecting an object in a surrounding region of the detected human based on the extracted features and determining human-object interaction information in the image based on the extracted features, the detected human and the detected object. The detection speed and detection precision of detecting the human, object and human-object interaction relationship from the video/image can be enhanced, and therefore the timeliness and accuracy of offering help to the human in need of help can be better met.

### CROSS-REFERENCE TO RELATED APPLICATIONS

This application claims the benefit of Chinese Patent Application No. 201910089715.1, filed Jan. 30, 2019, which is hereby incorporated by reference herein in its entirety.

### BACKGROUND OF THE INVENTION

### Field of the Invention

The present disclosure relates to image processing, in particular to a detection of human-object interaction in an image.

### Description of the Related Art

In monitoring scenes, in order to enable a human in need to be offered help in time, it is a critical task to quickly and timely detect interaction relationships between the human and objects (that is, human-object interaction relationships) from an image/a video, wherein human-object interaction relationships include that, for example, the human is on crutches, the human sits in a wheelchair, the human pushes a stroller, etc. For example, in a case where the human-object interaction relationship is that the human sits in a wheelchair or is on crutches, etc., the human is usually the one who needs to be helped.

In order to detect the human-object interaction relationship from the video/image, the non-patent document “Detecting and Recognizing the Human-Object Interactions” (Georgia Gkioxari Ross Girshick Piotr Dollar Kaiming He, Facebook AI Research, CVPR 2018) discloses an exemplary technique for detecting and recognizing human-object interaction relationships. Wherein, the exemplary technique is mainly as follows: firstly, features are extracted from an image by one neural network to detect all possible candidate regions of a human and objects in the image; then, features are extracted again from the detected candidate regions by another neural network, and the human, objects and human-object interaction relationship are detected respectively from the candidate regions by an object detection branch, a human detection branch and a human-object interaction relationship detection branch in the neural network based on the features extracted again.

As described above, it can be known that in the course of detecting the human-object interaction relationships from the video/image, the above exemplary technique needs to realize the corresponding detections by two independent stages. Wherein the operation of one stage is to detect all candidate regions of the human and all candidate regions of objects simultaneously from the image, and the operation of the other stage is to detect the human, objects and human-object interaction relationship from all candidate regions. Since for the operations of the two stages, it is required to perform network computation twice, especially required to perform feature extraction twice (for example, extracting features for detecting candidate regions of the human and objects and extracting features for detecting the human, objects and human-object interaction relationship), so as to spend more processing time for the whole detection processing, that is, influence the detection speed of detecting the human, objects and human-object interaction relationship from the video/image, and thus influence the timeliness of offering help to the human who need help.

### SUMMARY OF THE INVENTION

In view of the recordation of the above related art, the present disclosure is directed to address at least one of the above problems.

According to one aspect of the present disclosure, it is provided a detection apparatus comprising: a feature extraction unit which extracts features from an image; a human detection unit which detects a human in the image based on the features; an object detection unit which detects an object in a surrounding region of the detected human based on the features; and an interaction determination unit which determines human-object interaction information (human-object interaction relationship) in the image based on the features, the detected human and the detected object.

According to another aspect of the present disclosure, it is provided a detection method comprising: a feature extraction step of extracting features from an image; a human detection step of detecting a human in the image based on the features; an object detection step of detecting an object in a surrounding region of the detected human based on the features; and an interaction determination step of determining a human-object interaction information (human-object interaction relationship) in the image based on the features, the detected human and the detected object.

Wherein, in the present disclosure, at least one part of the detected human is determined based on a type of an object to be detected; wherein, the surrounding region is a region surrounding the determined at least one part. Wherein, in the present disclosure, the surrounding region is determined by determining a human pose of the detected human.

According to a further aspect of the present disclosure, it is provided an image processing apparatus comprising: an acquisition device for acquiring an image or a video; a storage device which stores instructions; and a processor which executes the instructions based on the acquired image or video, such that the processor implements at least the detection method described above.

According to a further aspect of the present disclosure, it is provided an image processing system comprising: an acquisition apparatus for acquiring an image or a video; the above detection apparatus for detecting the human, object and human-object interaction information from the acquired image or video; and a processing apparatus for executing subsequent image processing operations based on the detected human-object interaction information; wherein, the acquisition apparatus, the detection apparatus and the processing apparatus are connected each other via a network.

On the one hand, since the present disclosure acquires shared features which can be used by each operation from an image, the present disclosure can implement the detections of human, objects and human-object interaction relationship by one-stage processing, and thus the processing time of the whole detection processing can be reduced. On the other hand, since the present disclosure only needs to detect a human in an image firstly, and then determines a region from which an object is detected based on information of the detected human, such that the present disclosure can reduce the range of the object detection, and thus the detection precision of the whole detection processing can be improved and the processing time of the whole detection processing can be further reduced. Therefore, according to the present disclosure, the detection speed and detection precision of detecting human, objects and human-object interaction relationship from the video/image can be improved, so as to better meet the timeliness and accuracy for offering help to a human in need of help.

Further features and advantageous of the present disclosure will become apparent from the following description of typical embodiments with reference to the accompanying drawings.

### BRIEF DESCRIPTION OF THE DRAWINGS

The accompanying drawings, which are incorporated in and constitute a part of the specification, illustrate embodiments of the present disclosure, and together with the description of the embodiments, serve to explain the principles of the present disclosure.

FIG. 1 is a block diagram schematically showing a hardware configuration capable of implementing a technique according to an embodiment of the present disclosure.

FIG. 2 is a block diagram illustrating a configuration of a detection apparatus according to an embodiment of the present disclosure.

FIG. 3 schematically shows a schematic structure of a pre-generated neural network applicable to an embodiment of the present disclosure.

FIG. 4 schematically shows a flowchart of a detection method according to an embodiment of the present disclosure.

FIG. 5 schematically shows a flowchart of an object detection step S430 as shown in FIG. 4 according to an embodiment of the present disclosure.

FIGS. 6A˜6E schematically show an example of determining regions for detecting objects according to the present disclosure.

FIGS. 7A˜7C schematically show another example of determining regions for detecting objects according to the present disclosure.

FIG. 8 schematically shows a flowchart of a generation method for generating a neural network in advance applicable to an embodiment of the present disclosure.

FIG. 9 shows an arrangement of an exemplary image processing apparatus according to the present disclosure.

FIG. 10 shows an arrangement of an exemplary image processing system according to the present disclosure.

### DESCRIPTION OF THE EMBODIMENTS

Exemplary embodiments of the present disclosure will be described in detail below with reference to the accompanying drawings. It shall be noted that the following description is merely illustrative and exemplary in nature, and is in no way intended to limit the present disclosure and its applications or uses. The relative arrangement of components and steps, numerical expressions and numerical values set forth in the embodiments do not limit the scope of the present disclosure unless it is otherwise specifically stated. In addition, techniques, methods and devices known by persons skilled in the art may not be discussed in detail, but should be a part of the specification where appropriate.

Please note that similar reference numerals and letters refer to similar items in the drawings, and thus once an item is defined in one drawing, it is not necessary to discuss it in the following drawings.

In the course of detecting human-object interaction relationship, it is usually necessary to pay attention to the objects surrounding the human, especially the objects surrounding some parts of the human (for example, hands, lower-half-body, etc.). In other words, in the course of detecting the human-object interaction relationship, the detections of the human and objects are associated with each other rather than independent. Therefore, the inventor considers that, on the one hand, a human may be detected from an image firstly, then the associated objects may be detected from the image based on the information of the detected human (for example, position, posture, etc.), and the human-object interaction relationship can be determined based on the detected human and objects. On the other hand, since the detections of the human, objects and human-object interaction relationship are associated with each other, features (which can be regarded as Shared features) can be extracted from the whole image and simultaneously used in the detection of the human, the detection of objects and the detection of human-object interaction relationship. Thus, the present disclosure can realize the detections of the human, objects and human-object interaction relationship by one-stage processing.

Therefore, according to the present disclosure, the processing time of the whole detection processing can be reduced and the detection precision of the whole detection processing can be improved. Thus, according to the present disclosure, the detection speed and detection precision of detecting the human, objects and human-object interaction relationship from the video/image can be improved, so as to better meet the timeliness and accuracy of offering help to the human in need of help.

(Hardware Configuration)

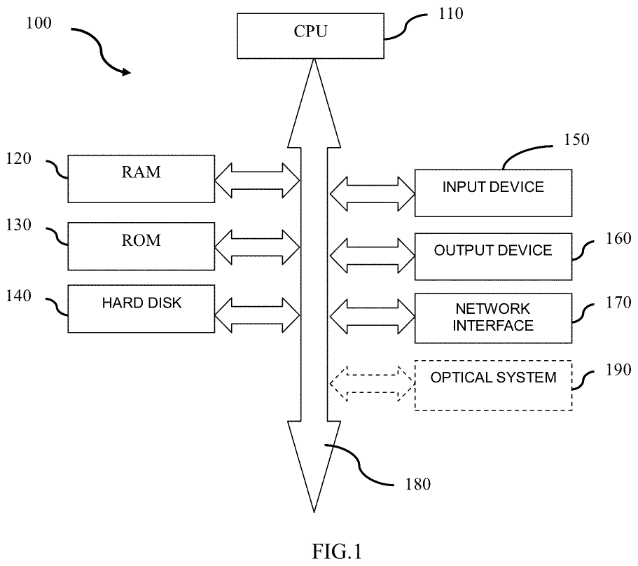

The hardware configuration which can realize the techniques described below will be described firstly with reference to FIG. 1.

Hardware configuration 100 include, for example, a central processing unit (CPU) 110, a random access memory (RAM) 120, a read-only memory (ROM) 130, a hard disk 140, an input device 150, an output device 160, a network interface 170, and a system bus 180. In addition, in one implementation, the hardware configuration 100 may be implemented by a computer, such as a tablet, laptop, desktop, or other suitable electronic devices. In another implementation, the hardware configuration 100 may be implemented by a monitoring device, such as a digital camera, a video camera, a network camera, or other suitable electronic devices. Wherein, in a case where the hardware configuration 100 is implemented by the monitoring device, the hardware configuration 100 also includes, for example, an optical system 190.

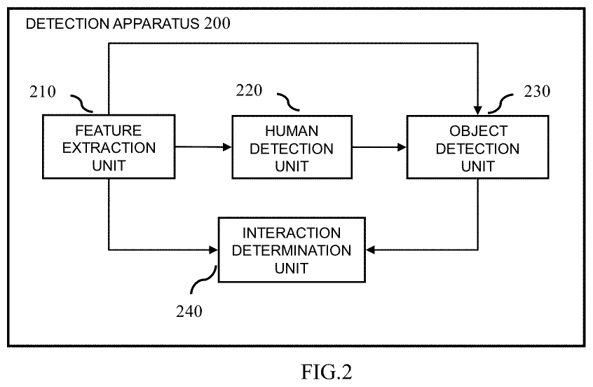

In one implementation, the detection apparatus according to the present disclosure is configured from a hardware or firmware and is used as a module or component of the hardware configuration 100. For example, a detection apparatus 200 to be described in detail below with reference to FIG. 2 is used as the module or component of the hardware configuration 100. In another implementation, the detection apparatus according to the present disclosure is configured by a software stored in the ROM 130 or the hard disk 140 and executed by the CPU 110. For example, a procedure 400 to be described in detail below with reference to FIG. 4 is used as a program stored in the ROM 130 or the hard disk 140.

CPU 110 is any suitable and programmable control device (such as a processor) and can execute various functions to be described below by executing various applications stored in the ROM 130 or the hard disk 140 (such as memory). RAM 120 is used to temporarily store programs or data loaded from the ROM 130 or the hard disk 140, and is also used as the space in which the CPU 110 executes various procedures (such as implementing the techniques to be described in detail below with reference to FIGS. 4 to 8) and other available functions. The hard disk 140 stores various types of information such as operating system (OS), various applications, control programs, videos, images, pre-generated networks (e.g., neural networks) and pre-defined data (e.g., conventional use manner of person for an object).

In one implementation, the input device 150 is used to allow the user to interact with the hardware configuration 100. In one example, the user may input a video/an image via the input device 150. In another example, the user may trigger the corresponding processing of the present disclosure by the input device 150. In addition, the input device 150 may be in a variety of forms, such as buttons, keyboards or touch screens. In another implementation, the input device 150 is used to receive a video/an image output from specialized electronic devices such as a digital camera, a video camera and/or a network camera. In addition, in a case where the hardware configuration 100 is implemented by the monitoring device, the optical system 190 in the hardware configuration 100 will directly capture the video/image of the monitoring site.

In one implementation, the output device 160 is used to display the detection results (such as the detected human, objects and human-object interaction relationship), to the user. Furthermore, the output device 160 may be in a variety of forms such as a cathode ray tube (CRT) or an LCD display. In another implementation, the output device 160 is used to output the detection results to the subsequent image processing, such as security monitoring and abnormal scene detection.

The network interface 170 provides an interface for connecting the hardware configuration 100 to the network. For example, the hardware configuration 100 may perform data communication with other electronic devices connected by means of the network via the network interface 170. Alternatively, the hardware configuration 100 may be provided with a wireless interface for wireless data communication. The system bus 180 may provide data transmission paths for transmitting data each other among the CPU 110, the RAM 120, the ROM 130, the hard disk 140, the input device 150, the output device 160, the network interface 170, the optical system 190 and so on. Although called a bus, the system bus 180 is not limited to any particular data transmission techniques.

The above hardware configuration 100 is merely illustrative and is in no way intended to limit the present disclosure, its applications or uses.

Moreover, for the sake of simplicity, only one hardware configuration is shown in FIG. 1. However, a plurality of hardware configurations may be used as required.

(Detection Apparatus and Method)

Next, the detection processing according to the present disclosure will be described with reference to FIG. 2 to FIG. 7C.

FIG. 2 is a block diagram illustrating the configuration of the detection apparatus 200 according to an embodiment of the present disclosure. Wherein some or all of the modules shown in FIG. 2 may be realized by the dedicated hardware. As shown in FIG. 2, the detection apparatus 200 includes a feature extraction unit 210, a human detection unit 220, an object detection unit 230 and an interaction determination unit 240.

At first, in one implementation, for example, in a case where the hardware configuration 100 shown in FIG. 1 is implemented by a computer, the input device 150 receives the image output from a specialized electronic device (for example, a camera, etc.) or input by the user. The input device 150 then transmits the received image to the detection apparatus 200 via the system bus 180. In another implementation, for example, in a case where the hardware configuration 100 is implemented by the monitoring device, the detection apparatus 200 directly uses the image captured by the optical system 190.

Then, as shown in FIG. 2, the feature extraction unit 210 extracts features from the received image (i.e., the whole image). In the present disclosure, the extracted features may be regarded as shared features. In one implementation, the feature extraction unit 210 extracts the shared features from the received image by using various feature extraction operators, such as Histogram of Oriented Gradient (HOG), Local Binary Pattern (LBP) and other operators.

The human detection unit 220 detects a human in the received image based on the shared features extracted by the feature extraction unit 210. In one implementation, the detection operation performed by the human detection unit 220 is to detect a region of the human from the image. In such implementation, the human detection unit 220 may detect the region of the human by using the existing region detection algorithm such as selective search algorithm, EdgeBoxes algorithm, Objectness algorithm and so on. In another implementation, the detection operation performed by the human detection unit 220 is to detect the key points of the human from the image. In this implementation, the human detection unit 220 may detect the key points of the human by using the existing key point detection algorithm such as Mask region convolution neural network (Mask R-CNN) algorithm and so on.

The object detection unit 230 detects objects in the surrounding region of the human detected by the human detection unit 220 based on the shared features extracted by the feature extraction unit 210. On the one hand, in the course of security monitoring or abnormal scene detection, the purpose of detection is usually definite. For example, it is required to detect whether there is a human sitting on a wheelchair or being on crutches in the image. Therefore, the type of object to be detected can be directly known according to the purpose of detection. Thus, at least one part of the detected human can be further determined based on the type of object to be detected, and the surrounding region is a region surrounding the determined at least one part. For example, in a case where the object to be detected is a crutch or wheelchair, the determined part of the human is, for example, the lower-half-body of the human. For example, in a case where the objects to be detected are a crutch and a parasol/umbrella, the determined parts of the human are, for example, the upper-half-body and lower-half-body of the human. For example, in a case where the objects to be detected are a crutch and a backpack, the determined parts of the human are, for example, the lower-half-body and the middle part of the human. Apparently, the present disclosure is not limited to these. On the other hand, as described above, the detection operation performed by the human detection unit 220 may be the detection of regions of a human or the detection of key points of a human. Therefore, in one implementation, in a case where the human detection unit 220 detects the regions of a human, the detection operation performed by the object detection unit 230 is the detection of regions of objects. Wherein the object detection unit 230 may also detect the regions of objects using, for example, the existing region detection algorithm described above. In another implementation, in a case where the human detection unit 220 detects the key points of a human, the detection operation performed by the object detection unit 230 is the detection of the key points of objects. Wherein the object detection unit 230 may also detect the key points of objects using, for example, the existing key point detection algorithm described above.

After detecting the human and objects in the received image, the interaction determination unit 240 determines human-object interaction information (that is, human-object interaction relationship) in the received image based on the shared features extracted by the feature extraction unit 210, the human detected by the human detection unit 220 and the objects detected by the object detection unit 230. In one implementation, the interaction determination unit 240 can determine the human-object interaction relationship for example using a pre-generated classifier based on the shared features, the detected human and objects. Wherein the classifier may be trained and obtained by using algorithms such as Support Vector Machine (SVM) based on the samples marked with the human, objects and human-object interaction relationship (that is, the conventional use manner by which human use the corresponding objects).

Finally, the human detection unit 220, the object detection unit 230 and the interaction determination unit 240, via the system bus 180 shown in FIG. 1, transmit the detection results (for example, the detected human, objects and human-object interaction relationship) to the output device 160, to display the detection results to the user, or output the detection results to the subsequent image processing such as security monitoring, abnormal scene detection and so on.

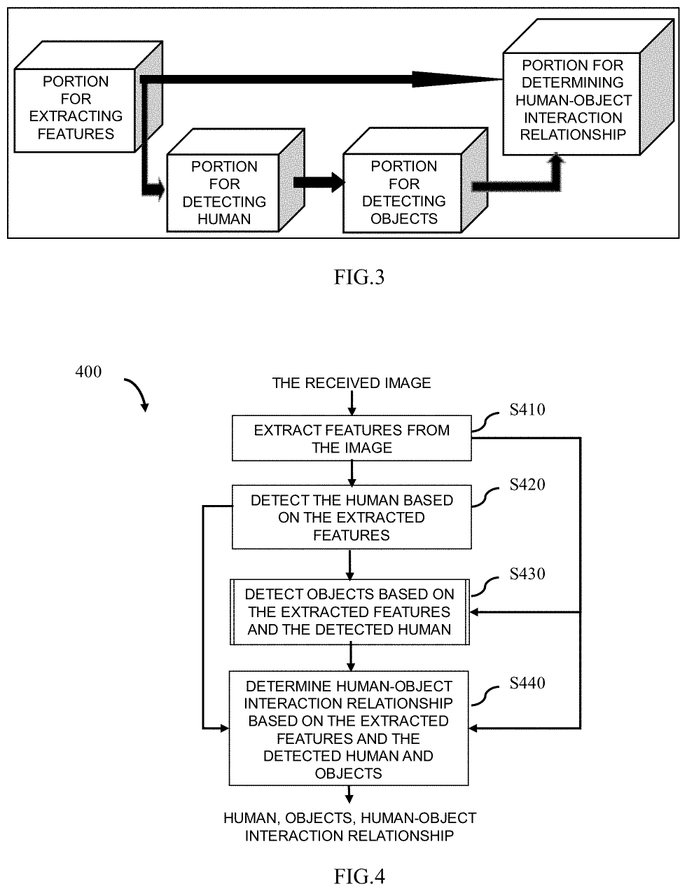

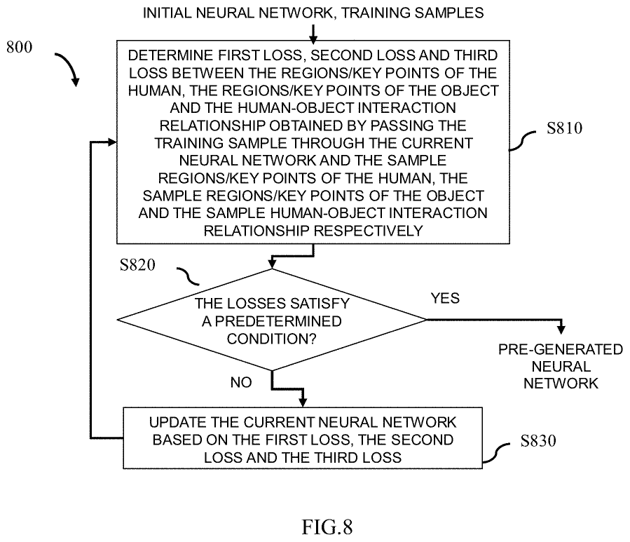

In addition, preferably, in one implementation, each unit in the detection apparatus 200 shown in FIG. 2 (i.e., the feature extraction unit 210, the human detection unit 220, the object detection unit 230 and the interaction determination unit 240) may execute the corresponding operations by using the pre-generated neural network. On the one hand, for example, as shown in FIG. 3, the pre-generated neural network applicable to the embodiments of the present disclosure includes, for example, a portion for extracting features, a portion for detecting human, a portion for detecting objects and a portion for determining human-object interaction relationship. Wherein, the method of generating the neural network in advance is described in detail below with reference to FIG. 8. On the other hand, the pre-generated neural network may be stored in a storage device (not shown). For example, the storage device may be the ROM 230 or the hard disk 240 as shown in FIG. 1. For example, the storage device may be a server or an external storage device connected to the detection apparatus 200 via a network (not shown).

Specifically, on the one hand, the detection apparatus 200 acquires the pre-generated neural network from the storage device. On the other hand, the feature extraction unit 210 extracts the shared features from the received image, by using the portion for extracting features of the neural network. The human detection unit 220 detects the human in the received image, by using the portion for detecting human of the neural network, based on the shared features extracted by the feature extraction unit 210. The object detection unit 230 detects the objects surrounding the human, by using the portion for detecting objects of the neural network, based on the shared features extracted by the feature extraction unit 210 and the human detected by the human detection unit 220. The interaction determination unit 240 determines the human-object interaction relationship in the received image, by using the portion for determining the human-object interaction relationship of the neural network, based on the shared features extracted by the feature extraction unit 210 and the human detected by the human detection unit 220 and the objects detected by the object detection unit 230.

The flowchart 400 shown in FIG. 4 is a corresponding procedure of the detection apparatus200 shown in FIG. 2.

As shown in FIG. 4, in the feature extraction step S410, the feature extraction unit 210 extracts the features (i.e., shared features) from the received image.

After obtaining the shared features, in the human detection step S420, the human detection unit 220 detects the human in the received image based on the shared features. Wherein, as described above, the detection operation performed by the human detection unit 220 may be to detect the region of the human from the image or the key points of the human from the image.

After detecting the human in the image, in the object detection step S430, the object detection unit 230 detects the objects in the region surrounding the detected human based on the shared features. In one implementation, the object detection unit 230 performs the corresponding object detection operation with reference to FIG. 5. In this case, the object detection unit 230 shown in FIG. 2 may include, for example, a region determination subunit (not shown) and an object detection subunit (not shown).

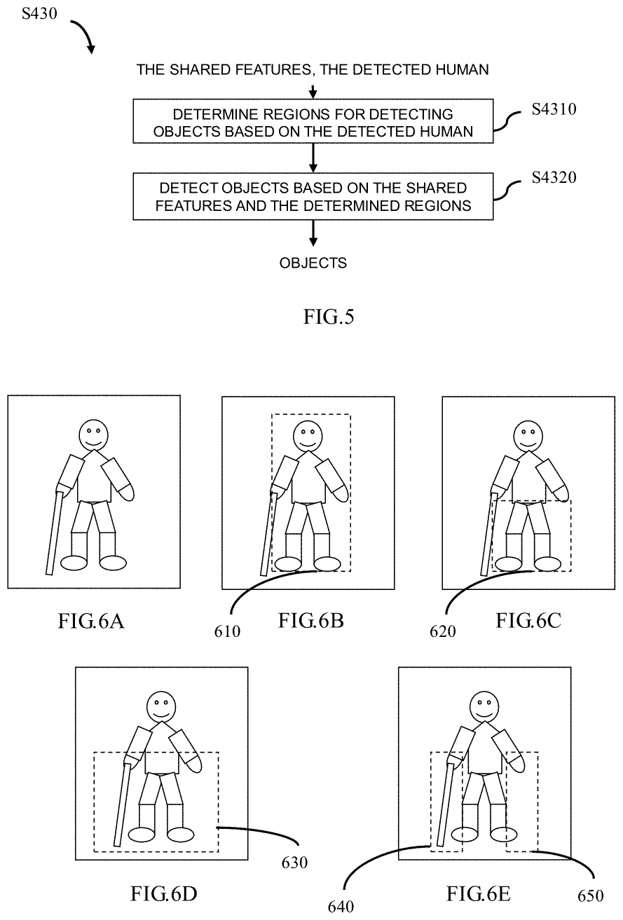

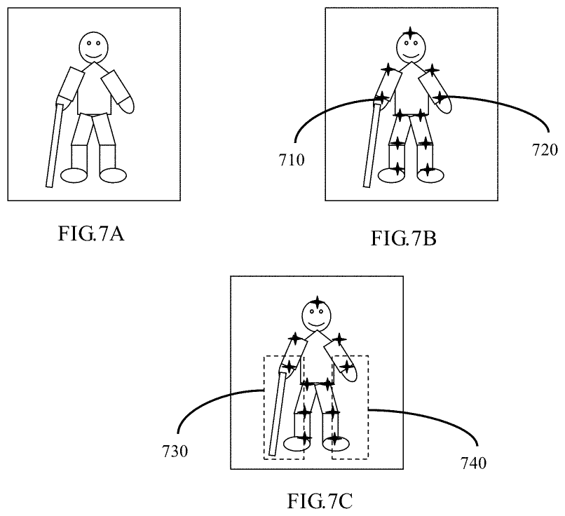

As shown in FIG. 5, in step S4310, the object detection unit 230 or the region determination subunit determines at least one part of the detected human and determines the surrounding region of the determined part as the region for detecting objects.

Wherein, regarding the determination of at least one part of the detected human, as described above, in the course of security monitoring or abnormal scene detection, since the purpose of detection is usually definite, at least one part can be determined from the detected human based on the type of the object to be detected. In the course of security monitoring, since the human who needs help is usually a person who usually uses a crutch or a wheelchair, the object to be detected is usually located in the region where the human's lower-half-body is located. Thus, preferably, the determined part of the human is, for example, the lower-half-body thereof. For example, as shown in FIGS. 6A˜6C, wherein FIG. 6A represents the received image, and a region 610 in FIG. 6B represents the region of the detected human. Since the type of the object to be detected is a crutch, the lower-half-body of the detected human (as shown in a region 620 in FIG. 6C) may be determined as a corresponding part.

Wherein, regarding the determination of the region surrounding the determined part (that is, the determination of the region for detecting the objects), in one implementation, for example, the region for detecting the objects may be determined by expanding the region where the determined part is located. For example, as shown in FIG. 6D, a region 630 in FIG. 6D represents the region for detecting objects, and it is directly obtained by expanding the region 620 in FIG. 6C. In another implementation, a human usually has a particular posture due to using certain kinds of objects, for example a human “sits” in wheelchair, a human “is” on crutches, a human “holds” an umbrella, a human “pushes” a baby stroller, etc., so in order to get the region for more effectively detecting the object to improve the detection speed for the object, for example the region for detecting the object can be determined by determining the human pose of the detected human. For example, it is assumed that the region for detecting the object is usually located at a position near the hand in the lower-half-body of the human by determining the human pose of the detected human as “being on a crutch by a hand”, thus, for example, as shown in FIG. 6E, a region 640 and a region 650 in FIG. 6E indicate the regions for detecting the object, and are obtained by combining the determined human pose based on the region 620 in FIG. 6C. In addition, as described above, the key points of the human and the key points of the object may be detected, in addition to the regions of the human and the object. Therefore, in a further implementation, in a case where the key points of the human are detected by the human detection unit 220, the region surrounding at least one of the detected key points of the human may be determined as a region for detecting the object (that is, detecting the key points of the object), wherein the more effective region for detecting the object may be obtained by this manner to improve the speed for detecting the object. For example, assuming that the human is usually on a crutch with the right hand, the region surrounding key points representing the right hand may be determined as the region for detecting the object. Of course, the region surrounding the key points representing the left hand and the region surrounding the key points representing the right hand may also be determined as the regions for detecting the object respectively. For example, as shown in FIGS. 7A˜7C, FIG. 7A indicates the received image, the star points in the FIG. 7B indicate the key points of the detected human, wherein the star point 710 indicates the key point of the right hand, the star point 720 indicates the key point of the left hand, a region 730 in FIG. 7C indicates the region for detecting the object (namely, the region surrounding the key point of the right hand), and a region740 in FIG. 7C indicates another region for detecting the object (namely, the region surrounding the key point of the left hand).

Return to FIG. 5, after the region for detecting the object is determined, in step S4320, the object detection unit 230 or the object detection subunit detects the object based on the shared features and the determined region (for example, detecting the region of the object or detecting the key points of the object).

Return to FIG. 4, after detecting the human and objects in the received image, in the interactive determination step S440, the interaction determination unit 240 determines the human-object interaction information (i.e., the human-object interaction relationship) in the received image based on the shared features and the detected human and objects. For example, as the image shown in FIG. 6A or FIG. 7A, the determined human-object interaction relationship is that the human is on a crutch with a hand.

Finally, the human detection unit 220, the object detection unit 230 and the interaction determination unit 240 transmit, via the system bus 180 shown in FIG. 1, the detection results (for example, the detected human, objects and human-object interaction relationship) to the output device 160, to display the detection results to the user, or output the detection results to the subsequent image processing such as security monitoring, abnormal scene detection and so on.

As described above, on the one hand, the present disclosure can realize the detections of the human, object and human-object interaction relationship by one-stage processing because the shared features that can be used by each operation are obtained from the image in the present disclosure, thus reducing the processing time of the whole detection processing. On the other hand, since the present disclosure only needs to detect the human in the image firstly, and then the region from which the object is detected is determined based on the information of the detected human, the present disclosure can narrow the scope of the object detection, so that the detection precision of the whole detection processing can be improved and thus further reduce the processing time of the whole detection processing. Therefore, according to the present disclosure, the detection speed and the detection precision of detecting the human, objects and human-object interaction relationship from the video/image can be improved, so as to better meet the timeliness and accuracy of providing help to a human who need help.

(Generation of Neural Network)

As described above, in the embodiments of the present disclosure, the corresponding operations may be performed by using a pre-generated neural network (for example the neural network shown in FIG. 3). In the present disclosure, the corresponding neural network can be generated in advance by using the deep learning method (e.g., neural network method) based on training samples in which regions/key points of the human, regions/key points of the objects and the human-object interaction relationships are marked.

In one implementation, in order to reduce the time required to generate the neural network, the portion for extracting features, the portion for detecting human, the portion for detecting objects and the portion for determining human-object interaction relationship in the neural network will be updated together in the manner of back propagation. FIG. 8 schematically shows a flowchart 800 of a generation method for generating a neural network applicable to the embodiments the present disclosure in advance. In the flowchart 800 shown in FIG. 8, it is described by taking a case where the corresponding neural network is generated by using the neural network method as an example. However, obviously, the present disclosure is not limited to this. Wherein, the generation method with reference to FIG. 8 may also be executed by the hardware configuration 100 shown in FIG. 1.

As shown in FIG. 8, CPU 110 as shown in FIG. 1 acquires the pre-set initial neural network and a plurality of training samples by the input device 150 firstly. Wherein regions/key points of the human, regions/key points of the object and the human-object interaction relationship are marked in each training sample.

Then, in step S810, on the one hand, CPU 110 passes the training sample through the current neural network (for example, the initial neural network) to obtain the regions/key points of the human, the regions/key points of the object and the human-object interaction relationship. In other words, CPU 110 sequentially passes the training sample through the portion for extracting features, the portion for detecting human, the portion for detecting objects and the portion for determining human-object interaction relationship in the current neural network to obtain the regions/key points of the human, the regions/key points of the object and the human-object interaction relationship. On the other hand, for the obtained regions/key points of the human, CPU 110 determines the loss between the obtained regions/key points of the human and the sample regions/key points of the human (for example, the first loss, Loss1). Wherein, the sample regions/key points of the human may be obtained according to the regions/key points of the human marked in the training sample. Wherein, the first loss Loss1 represents the error between the predicted regions/key points of the human obtained by using the current neural network and the sample regions/key points of the human (i.e., real regions/key points), wherein the error may be evaluated by distance, for example.

For the obtained regions/key points of the object, CPU 110 determines the loss between the obtained regions/key points of the object and the sample regions/key points of the object (for example, the second loss, Loss2). Wherein, the sample regions/key points of the object may be obtained according to the regions/key points of the object marked in the training sample. Wherein the second loss Loss2 represents the error between the predicted regions/key points of the object obtained by using the current neural network and the sample regions/key points of the object (i.e., real regions/key points), wherein the error may be evaluated by distance, for example.

For the obtained human-object interaction relationship, CPU 110 determines the loss between the obtained human-object interaction relationship and the sample human-object interaction relationship (for example, the third loss, Loss3). Wherein, the sample human-object interaction relationship can be obtained according to the human-object interaction relationship marked in the training sample. Wherein, the third loss Loss3 represents the error between the predicted human-object interaction relationship obtained by using the current neural network and the sample human-object interaction relationship (that is, the real human-object interaction relationship), wherein the error may be evaluated by distance, for example.

Returning to FIG. 8, in step S820, CPU 110 will judge whether the current neural network satisfies a predetermined condition based on the determined all losses (i.e., the first loss Loss1, the second loss Loss2 and the third loss Loss3). For example, the sum/weighted sum of the three losses is compared with a threshold (for example, TH1), and in a case where the sum/weighted sum of the three losses is less than or equal to the TH1, it is judged that the current neural network satisfies the predetermined condition and is output as the final neural network (that is, as a pre-generated neural network), wherein the final neural network, for example, can be output to the ROM 130 or the hard disk 140 shown in FIG. 1, to be used to the detection operations described in FIGS. 2˜7C. In a case where the sum/weighted sum of the three losses is greater than the TH1, it is judged that the current neural network does not satisfy the predetermined condition, and the generation process will proceed to step S830.

In step S830, CPU 110 updates the current neural network based on the first loss Loss1, the second loss Loss2 and the third loss Loss3, that is, sequentially updates parameters of each layer in the portion for determining human-object interaction relationship, the portion for detecting objects, the portion for detecting human and the portion for extracting features in the current neural network. Herein, the parameters of each layer are, for example, the weight values in each convolutional layer in each of the above portions. In one example, for example, the parameters of each layer are updated based on the first loss Loss1, the second loss Loss2 and the third loss Loss3 by using stochastic gradient descent method. Thereafter, the generation process proceeds to step S810 again.

In the flow chart 800 shown in FIG. 8, whether the sum/weighted sum of the three losses (the first loss Loss1, the second loss Loss2 and the third loss Loss3) satisfies the predetermined conditions is taken as the condition to stop updating the current neural network. However, apparently, the present disclosure is not limited to this. Alternatively, for example, step S820 may be omitted, but the corresponding update operation is stopped after the number of updating the current neural network reaches a predetermined number.

(Application)

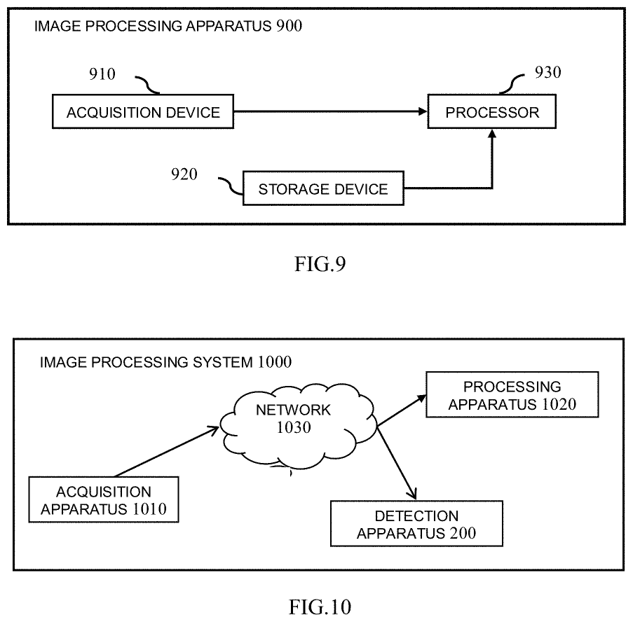

In addition, as described above, the present disclosure can be implemented by a monitoring device (for example, a network camera). Therefore, as one application, by taking a case where the present disclosure is implemented by the network camera as an example, FIG. 9 shows an arrangement of an exemplary image processing apparatus 900 according to the present disclosure. As shown in FIG. 9, the image processing apparatus 900 includes at least an acquisition device 910, a storage device 920 and a processor 930. Obviously, the image processing apparatus 900 may also include an input device, an output device and so on which are not shown.

As shown in FIG. 9, firstly, the acquisition device 910 (for example, the optical system of the network camera) captures the image/video of the place of interest (for example, the monitoring site) and transmits the captured image/video to the processor 930. Wherein the above monitoring site may be places that require security monitoring, abnormal scene detection, etc.

The storage device 920 stores instructions, wherein the stored instructions are at least instructions corresponding to the detection method described in FIGS. 4˜7C.

The processor 930 executes the stored instructions based on the captured image/video, such that at least the detection method described in FIGS. 4˜7C can be implemented, so as to detect the human, objects and human-object interaction relationship in the captured image/video.

In addition, in a case where the storage device 920 also stores the subsequent image processing instructions, for example it is judged whether there are the abnormal scenes in the monitoring site (for example, whether there is a human in need of help), the processor 930 may also implement the corresponding operation by executing the corresponding subsequent image processing instructions based on the detected human-object interaction relationship. In this case, for example, an external display apparatus (not shown) may be connected to the image processing apparatus 900 via the network, so that the external display apparatus may output the subsequent image processing results (for example, the appearance of a human in need of help, etc.) to the user/monitoring personnel. Alternatively, the above subsequent image processing instructions may also be executed by an external processor (not shown). In this case, the above subsequent image processing instructions, for example, are stored in an external storage device (not shown), and the image processing apparatus 900, the external storage device, the external processor and the external display apparatus may be connected via the network, for example. Thus, the external processor may execute the subsequent image processing instructions stored in the external storage device based on the human-object interaction relationship detected by the image processing apparatus 900, and the external display apparatus can output the subsequent image processing results to the user/monitoring personnel.

In addition, as described above, the present disclosure may also be implemented by a computer (for example, a client server). Therefore, as one application, by taking a case where the present disclosure is implemented by the client server as an example, FIG. 10 shows an arrangement of an exemplary image processing system 1000 according to the present disclosure. As shown in FIG. 10, the image processing system 1000 includes an acquisition apparatus 1010 (for example, at least one network camera), a processing apparatus 1020 and the detection apparatus 200 as shown in FIG. 2, wherein the acquisition apparatus 1010, the processing apparatus 1020 and the detection apparatus 200 are connected each other via the network 1030. Wherein, the processing apparatus 1020 and the image processing apparatus 200 may be realized by the same client server, or by different client servers respectively.

As shown in FIG. 10, firstly, the acquisition apparatus 1010 captures the image or video of the place of interest (for example, the monitoring site) and transmits the captured image/video to the detection apparatus 200 via the network 1030. Wherein, the above monitoring site for example may be places that require security monitoring, abnormal scene detection, etc.

The detection apparatus 200 detects the human, objects and human-object interaction relationship from the captured image/video with reference to FIGS. 2˜7C.

The processing apparatus 1020 executes subsequent image processing operations based on the detected human-object interaction relationship, for example it is judged whether there are abnormal scenes in the monitoring site (for example, whether there is a human in need of help), and so on. For example, the detected human-object interaction relationship may be compared with a predefined abnormal rule to judge whether there is a human in need of help. For example, it is assumed that the predefined abnormal rule is “in a case where there is a human who is on a crutch or sits in a wheelchair, the human is in need of help”, a display apparatus or an alarm apparatus may be connected by the network 1030 to output the corresponding image processing results (for example, there is a human in need of help, etc.) to the user/monitoring personnel, in a case where the detected human-object interaction relationship is “a human is on a crutch or sits in a wheelchair”.

All of the above units are exemplary and/or preferred modules for implementing the processing described in the present disclosure. These units may be hardware units (such as field programmable gate array (FPGA), digital signal processors, application specific integrated circuits, etc.) and/or software modules (such as computer readable programs). The units for implementing each step are not described in detail above. However, in a case where there is a step to execute a particular procedure, there may be the corresponding functional module or unit (implemented by hardware and/or software) for implementing the same procedure. The technical solutions constituted by all combinations of the described steps and the units corresponding to these steps are included in the disclosure contents of the present application, as long as the technical solutions they constitute are complete and applicable.

The methods and apparatuses of the present disclosure may be implemented in a variety of manners. For example, the methods and apparatuses of the present disclosure may be implemented by software, hardware, firmware or any combination thereof. Unless otherwise specified, the above sequence of steps in the present method is intended only to be illustrative and the steps in the method of the present disclosure are not limited to the specific sequence described above. In addition, in some embodiments, the present disclosure may also be implemented as a program recorded in a recording medium including machine-readable instructions for implementing the methods according to the present disclosure. Therefore, the present disclosure also covers a recording medium for storing a program for realizing the methods according to the present disclosure.

Although some specific embodiments of the present disclosure have been demonstrated in detail with examples, it should be understood by a person skilled in the art that the above embodiments are only intended to be illustrative but not to limit the scope of the present disclosure. It should be understood by a person skilled in the art that the above embodiments can be modified without departing from the scope and spirit of the present disclosure. The scope of the present disclosure is defined by the attached claims.

What is claimed is:

1. A detection apparatus comprising:
a feature extraction unit which extracts features from an image;
a human detection unit which detects a human in the image based on the features;
an object detection unit which detects an object in a surrounding region of the detected human based on the features; and
an interaction determination unit which determines human-object interaction information in the image based on the features, the detected human and the detected object.

2. The detection apparatus according to claim 1, wherein the human detection unit and the object detection unit are configured to detect regions of the human and the object or detect key points of the human and the object.

3. The detection apparatus according to claim 2, wherein at least one part of the detected human is determined based on a type of an object to be detected; wherein, the surrounding region is a region surrounding the determined at least one part.

4. The detection apparatus according to claim 3, wherein the determined at least one part is the lower-half-body of the detected human.

5. The detection apparatus according to claim 3, wherein the surrounding region is determined by determining a human pose of the detected human.

6. The detection apparatus according to claim 3, wherein in a case where the key points of the human are detected, the surrounding region is a region surrounding at least one of the key points of the human.

7. The detection apparatus according to claim 1, wherein, the feature extraction unit, the human detection unit, the object detection unit and the interaction determination unit execute corresponding operations by using a pre-generated neural network.

8. A detection method comprising:
a feature extraction step of extracting features from an image;
a human detection step of detecting a human in the image based on the features;
an object detection step of detecting an object in a surrounding region of the detected human based on the features; and
an interaction determination step of determining a human-object interaction information in the image based on the features, the detected human and the detected object.

9. The detection method according to claim 8, wherein the human detection step and the object detection step are configured to detect regions of the human and the object or detect key points of the human and the object.

10. The detection method according to claim 9, wherein at least one part of the detected human is determined based on a type of an object to be detected, wherein the surrounding region is a region surrounding the determined at least one part.

11. The detection method according to claim 10, wherein the surrounding region is determined by determining a human pose of the detected human

12. The detection method according to claim 10, wherein in a case where the key points of the human are detected, the surrounding region is a region surrounding at least one of the key points of the human.

13. An image processing apparatus comprising:
an acquisition device for acquiring an image or a video;
a storage device which stores instructions; and
a processor which executes the instructions based on the acquired image or video, such that the processor implements at least the detection method according to claim 8.

14. An image processing system comprising:
an acquisition apparatus for acquiring an image or a video;
a detection apparatus including a feature extraction unit which extracts features from an image, a human detection unit which detects a human in the image based on the features, an object detection unit which detects an object in a surrounding region of the detected human based on the features and an interaction determination unit which determines human-object interaction information in the image based on the features, the detected human and the detected object, for detecting the human, object and human-object interaction information from the acquired image or video; and
a processing apparatus for executing subsequent image processing operations based on the detected human-object interaction information,
wherein, the acquisition apparatus, the detection apparatus and the processing apparatus are connected to each other via a network.
